(19) United States
(12) Patent Application Publication
(10) Pub. No.: US 2012/0207131 A1
(43) Pub. Date: Aug. 16, 2012

(54) Method and Apparatus for Continuing HSPA During Baton Handover in TD-SCDMA Systems

(76) Inventors: Tom Chin, San Diego, CA (US); Guangming Shi, San Diego, CA (US); Kuo-Chun Lee, San Diego, CA (US)

(21) Appl. No.: 13/384,202

(22) PCT Filed: May 8, 2010
(86) PCT No.: PCT/US10/34157

§ 371 Date: Jan. 13, 2012

Related U.S. Application Data
(60) Provisional application No. 61/257,687, filed on Nov. 3, 2009.

(51) Int. Cl. H04W 36/00

(52) U.S. Cl. 370/331

(57) ABSTRACT

Certain aspects of the present disclosure propose techniques for continuing high-speed packet access (HSPA) during the baton handover in Time Division Synchronous Code Division Multiple Access (TD-SCD-MA) systems. In aspects of the disclosure, one techniques for performing a baton handover from a source node B (NB) to a target NB by a user equipment (UE) is provided. The technique generally includes receiving a first signal instructing the UE to perform the baton handover from the source NB to the target NB, the first signal including non-scheduled transmission grant information and transmitting data to the target NB during the baton handover in accordance with the non-scheduled transmission grant information, wherein the data is re-transmitted to the target NB a predetermined number of times.

### CROSS-REFERENCE TO RELATED APPLICATIONS

This application claims the benefit of U.S. Provisional Patent Application No. 61/257,687, entitled, “METHOD AND APPARATUS FOR CONTINUING HSPA DURING BATON HANDOVER IN TD-SCDMA SYSTEMS,” filed on Nov. 3, 2009, which is expressly incorporated by reference herein in its entirety.

### BACKGROUND

1. Field

Aspects of the present disclosure relate generally to wireless communication systems, and more particularly, to a method to continue high-speed packet access (HSPA) during a handover in Time Division Synchronous Code Division Multiple Access (TD-SCDMA) systems.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but, to advance and enhance the user experience with mobile communications.

### SUMMARY

In an aspect of the disclosure, a method for performing a baton handover from a source node B (NB) to a target NB by a user equipment (UE) is provided. The method generally includes receiving a first signal instructing the UE to perform the baton handover from the source NB to the target NB, the first signal including non-scheduled transmission grant information and transmitting data to the target NB during the baton handover in accordance with the non-scheduled transmission grant information, wherein the data is re-transmitted to the target NB a predetermined number of times.

In an aspect of the disclosure, an apparatus for performing a baton handover from a source node B (NB) to a target NB by a user equipment (UE) is provided. The apparatus generally includes means for receiving a first signal instructing the UE to perform the baton handover from the source NB to the target NB, the first signal including non-scheduled transmission grant information and means for transmitting data to the target NB during the baton handover in accordance with the non-scheduled transmission grant information, wherein the data is re-transmitted to the target NB a predetermined number of times.

In an aspect of the disclosure, an apparatus for performing a baton handover from a source node B (NB) to a target NB by a user equipment (UE) is provided. The apparatus generally includes at least one processor configured to receive a first signal instructing the UE to perform the baton handover from the source NB to the target NB, the first signal including non-scheduled transmission grant information and transmit data to the target NB during the baton handover in accordance with the non-scheduled transmission grant information, wherein the data is re-transmitted to the target NB a predetermined number of times; and a memory coupled to the at least one processor.

In an aspect of the disclosure, a computer-program product for performing a baton handover from a source node B (NB) to a target NB by a user equipment (UE) is provided. The computer-program product generally includes a computer-readable medium comprising code for receiving a first signal instructing the UE to perform the baton handover from the source NB to the target NB, the first signal including non-scheduled transmission grant information and transmitting data to the target NB during the baton handover in accordance with the non-scheduled transmission grant information, wherein the data is re-transmitted to the target NB a predetermined number of times.

In an aspect of the disclosure, a method for instructing a user terminal (UE) to perform a baton handover from a source NB to a target NB is provided. The method generally includes sending a signal instructing the UE to perform the baton handover from the source NB to the target NB, the signal including non-scheduled transmission grant information for the UE to transmit data to the target NB during the baton handover and continuing to transmit data to the UE during the handover transition period, wherein the data is re-transmitted to the UE for a predetermined number of times.

In an aspect of the disclosure, an apparatus for instructing a user terminal (UE) to perform a baton handover from a source NB to a target NB is provided. The apparatus generally includes means for sending a signal instructing the UE to perform the baton handover from the source NB to the target NB, the signal including non-scheduled transmission grant information for the UE to transmit data to the target NB during the baton handover and means for continuing to transmit data to the UE during the handover transition period, wherein the data is re-transmitted to the UE for a predetermined number of times.

In an aspect of the disclosure, an apparatus for instructing a user terminal (UE) to perform a baton handover from a source NB to a target NB is provided. The apparatus generally includes at least one processor configured to send a signal instructing the UE to perform the baton handover from the source NB to the target NB, the signal including non-scheduled transmission grant information for the UE to transmit data to the target NB during the baton handover and continue to transmit data to the UE during the handover transition period, wherein the data is re-transmitted to the UE for a predetermined number of times; and a memory coupled to the at least one processor.

In an aspect of the disclosure, a computer-program product for instructing a user terminal (UE) to perform a baton handover from a source NB to a target NB is provided. The computer-program product generally includes a computer-readable medium comprising code for sending a signal instructing the UE to perform the baton handover from the source NB to the target NB, the signal including non-scheduled transmission grant information for the UE to transmit data to the target NB during the baton handover and continuing to transmit data to the UE during the handover transition period, wherein the data is re-transmitted to the UE for a predetermined number of times.

In an aspect of the disclosure, a method for communicating with a user terminal (UE) during a baton handover from a source base station (NB) to a target NB is provided. The method generally includes establishing a channel for receiving data transmissions from the UE during the baton handover during which the target NB does not transmit to the UE and receiving data transmissions from the UE transmitted on the channel in accordance with non-scheduled transmission grant information, wherein the data is re-transmitted to the UE for a predetermined number of times.

In an aspect of the disclosure, an apparatus for communicating with a user terminal (UE) during a baton handover from a source base station (NB) to a target NB is provided. The apparatus generally includes means for establishing a channel for receiving data transmissions from the UE during the baton handover during which the target NB does not transmit to the UE and means for receiving data transmissions from the UE transmitted on the channel in accordance with non-scheduled transmission grant information, wherein the data is re-transmitted to the UE for a predetermined number of times.

In an aspect of the disclosure, an apparatus for communicating with a user terminal (UE) during a baton handover from a source base station (NB) to a target NB is provided. The apparatus generally includes at least one processor configured to establish a channel for receiving data transmissions from the UE during the baton handover during which the target NB does not transmit to the UE and receive data transmissions from the UE transmitted on the channel in accordance with non-scheduled transmission grant information, wherein the data is re-transmitted to the UE for a predetermined number of times; and a memory coupled to the at least one processor.

In an aspect of the disclosure, a computer-program product for communicating with a user terminal (UE) during a baton handover from a source base station (NB) to a target NB. The computer-program product generally includes a computer-readable medium comprising code for establishing a channel for receiving data transmissions from the UE during the baton handover during which the target NB does not transmit to the UE and receiving data transmissions from the UE transmitted on the channel in accordance with non-scheduled transmission grant information, wherein the data is re-transmitted to the UE for a predetermined number of times.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIGS. 4A-4C are diagrams conceptually illustrating an example of a baton handover.

FIG. 5 is a diagram conceptually illustrating an example non-scheduled transmission grant in accordance with certain aspects of the present disclosure.

FIG. 6 is a diagram conceptually illustrating an example exchange of messages during a baton handover in accordance with certain aspects of the present disclosure.

FIG. 7 is a functional block diagram conceptually illustrating example blocks executed to implement the functional characteristics of one aspect of the present disclosure.

FIG. 8 is a functional block diagram conceptually illustrating example blocks executed to implement the functional characteristics of one aspect of the present disclosure.

FIG. 9 is a functional block diagram conceptually illustrating example blocks executed to implement the functional characteristics of one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

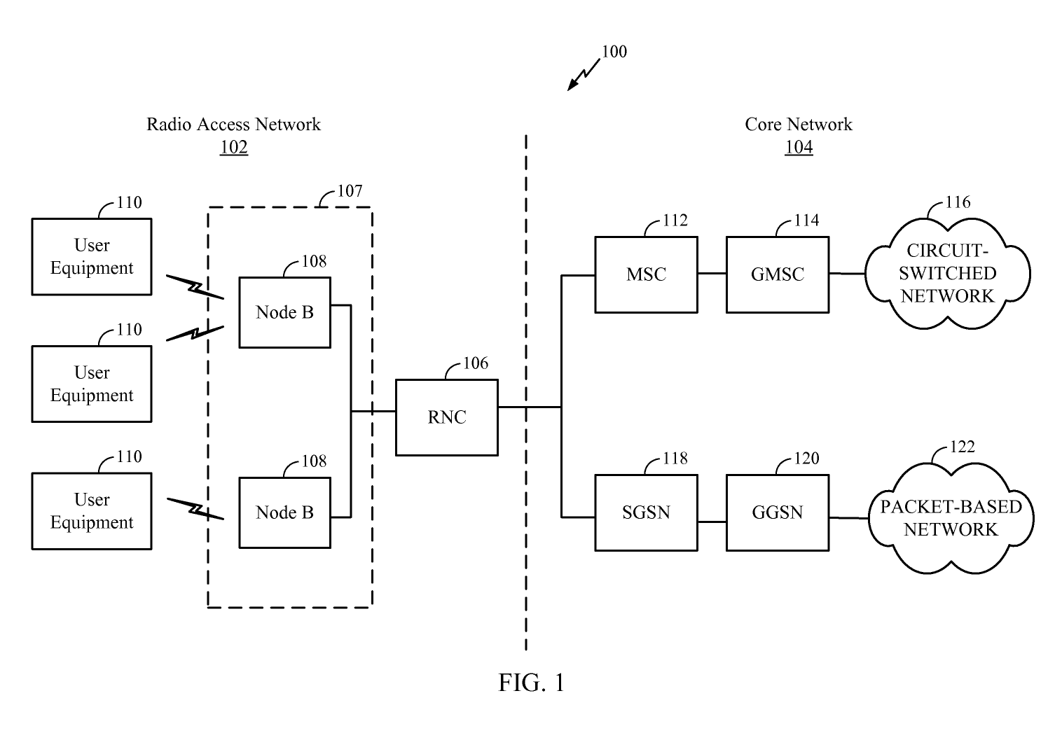

Turning now to FIG. 1, a block diagram is shown illustrating an example of a telecommunications system 100. The various concepts presented throughout this disclosure may be implemented across a broad variety of telecommunication systems, network architectures and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

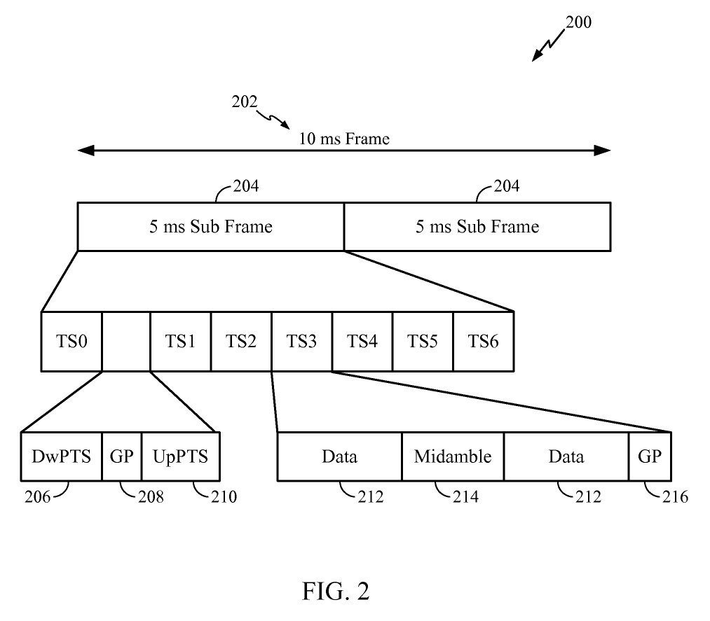

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

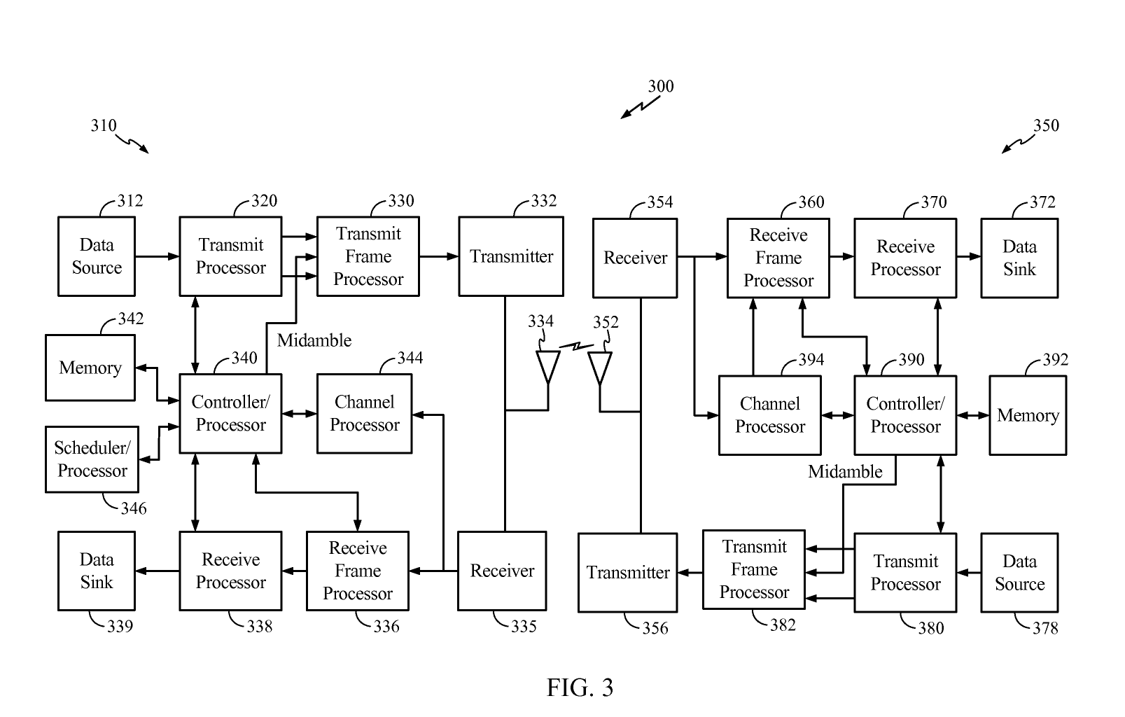

FIG. 3 is a block diagram of a Node B 310 in communication with a UE 350 in a RAN 300, where the RAN 300 may be the RAN 102 in FIG. 1, the Node B 310 may be the Node B 108 in FIG. 1 and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

### An Example Baton Handover

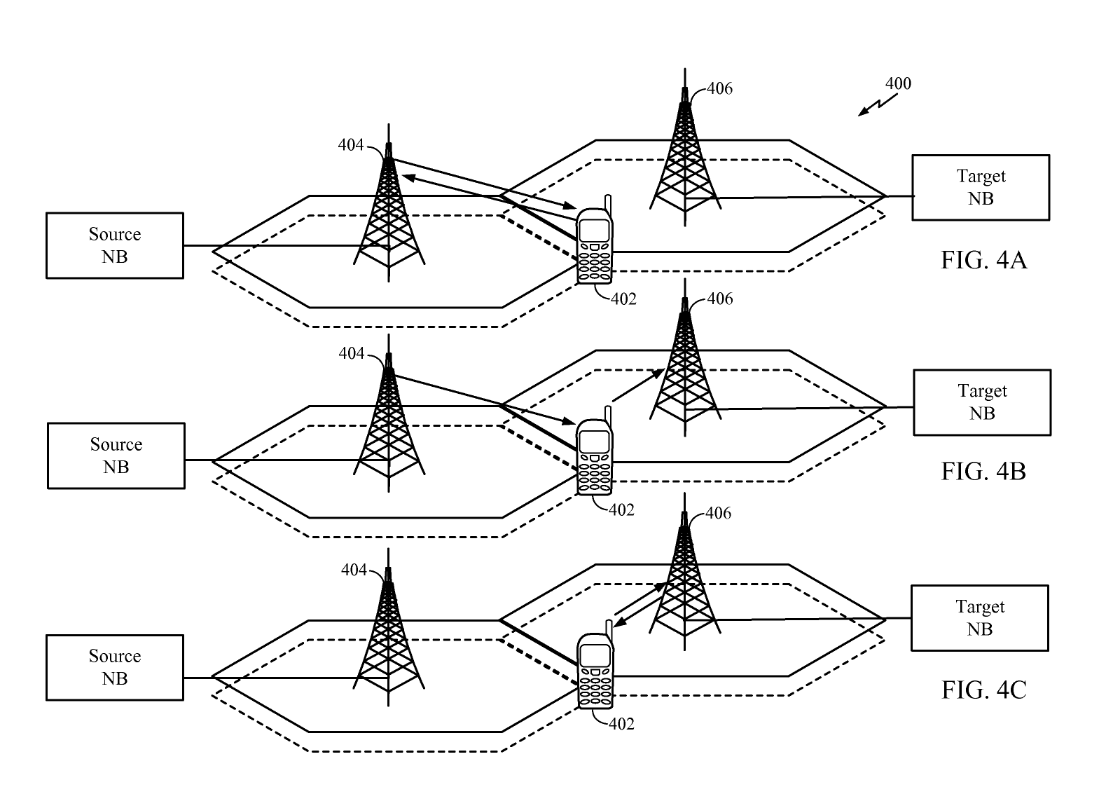

FIGS. 4A-4C illustrate an example of baton handover in the TD-SCDMA system, such as the system 100, in accordance with certain aspects of the present disclosure. As illustrated in FIG. 4A, a user equipment (UE) 402 may communicate on both downlink and uplink with a source cell and its Node B 404. The network may send (via the source NB) a PHYSICAL CHANNEL RECONFIGURATION message to the UE 402 to command the start of the baton handover. As illustrated in FIG. 4B, during a handover transition period, the UE 402 may switch the uplink to the target cell and its Node B 406, while still maintaining the downlink communications with the source cell and its Node B. Following this transition period, the UE 402 may finally switch the downlink to the target cell and its Node B 406, as illustrated in FIG. 4C.

The UE 402 may be able only to transmit or receive from one cell at one time, therefore during the transition period shown in FIG. 4B, the UE 402 may not be able to report CQI and ACK/NACK to the source cell that transmits the high-speed downlink data because the UE 402 may transmit to the target cell during the baton handover. Similarly, the UE 402 may not be able to receive absolute grant and HARQ ACK/NACK messages from the target cell because the downlink may still remain in the source cell.

Certain aspects of the present disclosure, however, may help allow high-speed packet data transmission to continue while the baton handover is in progress. The techniques provided herein may allow higher data throughput to be achieved during the baton handover procedure than conventional systems.

According to certain aspects, a source NB may send Non-scheduled transmission grant information (e.g., in an information element IE) in a PHYSICAL CHANNEL RECONFIGURATION message sent to the UE to trigger a baton handover. The PHYSICAL CHANNEL RECONFIGURATION message may include information to establish the new physical channel to be used in the target cell. The additional Non-scheduled transmission grant info IE may be used to schedule a periodic uplink (E-PUCH) transmission grant at the target cell, which may be beneficial since the lack of DL communications may prevent the target cell from sending absolute transmission grants to the UE.

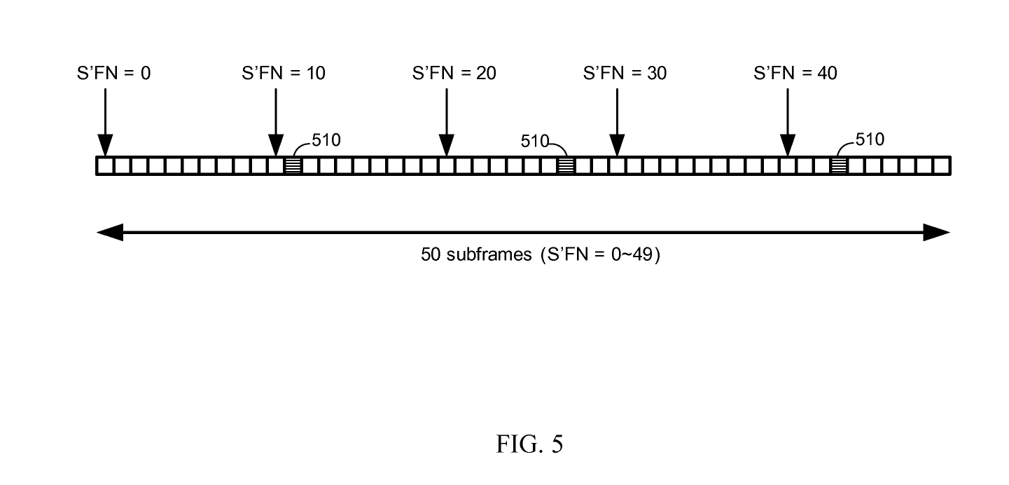

FIG. 5 illustrates an example of non-scheduled transmission grant that may be communicated to the UE via the PHYSICAL CHANNEL RECONFIGURATION message. As illustrated, particular subframes 510 occurring at periodic intervals may be designated for uplink transmissions to the target NB by the UE. As described above, each frame may include 2 subframes (subframe #0 and subframe #1). The example in FIG. 5 assumes a repetition period of 16 subframes, a repetition length of 1 subframe, and an specified activation time of frame #5, subframe #1 (i.e. system subframe number S′FN 11). In other words, the subframes 510 designated for uplink transmissions may occur every 16 subframes, with the first occurring in the second subframe (#1) of frame #5.

The repetition length may be used to indicate a number of re-transmissions, which may be used to achieve robust communications given the inability of the UE to receive ACK/NACKs from the UE during the baton handover transition period. According to certain aspects, the target NB may perform some type of combining (e.g., a soft combining algorithm) to take advantage of the retransmissions to achieve more reliable decoding of uplink transmissions from the UE. As will be described in greater detail below, the source NB may also use a predetermined number of re-transmissions on the DL. According to certain aspects the UE may also perform some type of combining to take advantage of the retransmissions to achieve more reliable decoding of the DL transmissions from the source NB.

### An Example Baton Handover With Continued HSPA

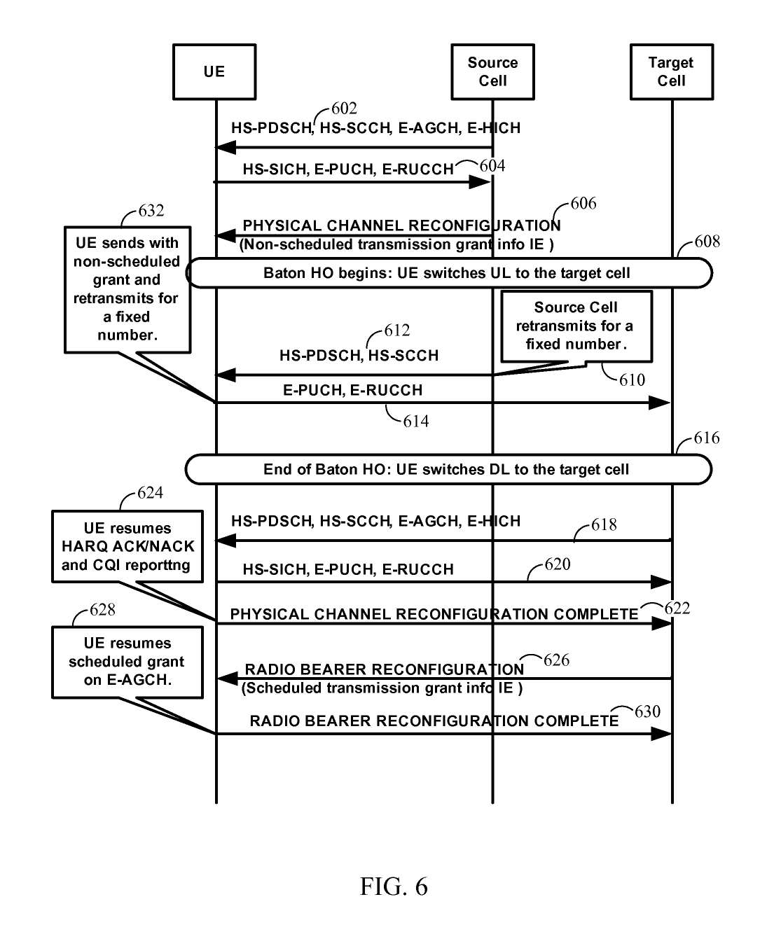

FIG. 6 illustrates an example exchange of messages during a baton handover of a UE from a NB in a source cell to a NB in a target cell, in accordance with certain aspects of the present disclosure.

As illustrated, the source cell may initially transmit data and control information to the UE via downlink channels 602 (including HS-PDSCH to transmit downlink user data, HS-SCCH to indicate modulation/coding scheme as well as channelization code and time slot resource information for the data in HS-PDSCH, E-AGCH to indicate the uplink absolute grant control information, and E-HICH to transmit the HARQ ACK/NACK of the E-PUCH transmission), while the UE may transmit to the source cell via uplink channels 604 (including HS-SICH to transmit CQI and HARQ ACK/NACK of the HS-PDSCH transmission, E-PUCH to transmit the uplink user data, and E-RUCCH to transmit associated uplink control signaling).

The UE may begin a baton handover, which is triggered by the source cell sending the PHYSICAL CHANNEL RECONFIGURATION message, at 606. In response, the UE may switch the UL channels to the target cell. The PHYSICAL CHANEL RECONFIGURATION message may include the new physical channel information to be used in the target cell.

In addition, according to certain aspects, the PHYSICAL CHANEL RECONFIGURATION message may also include a Non-scheduled transmission grant info IE to schedule a periodic E-PUCH transmission grant at the target cell.

At 608, the UE switches to use the E-PUCH, E-RUCCH (614) of the target cell while maintaining the HS-PDSCH, HS-SCCH (612) with the source cell.

As illustrated, the UE does not send HS-SICH in the target cell and does not receive E-AGCH and E-HICH in the source cell. This is because the target cell does not have capability to forward the information to the source cell.

The source cell can continue to schedule DL transmission but does not receive the HARQ ACK/NACK from the UE. As noted at 610, however, the source cell may pre-set a certain number of retransmissions for downlink transmissions without responding according to the HARQ ACK/NACK feedback (which the UE cannot provide). According to certain embodiments, since the UE cannot provide CQI either, the source cell may continue to use the old CQI to determine the modulation/coding scheme to be used. The UE may, thus, continue to decode the high-speed DL data from the source cell without reporting HARQ ACK/NACK and CQI.

The UE may continue to transmit on the UL using the non-scheduled transmission grant, but does not receive HARQ ACK/NACKs from the target cell. Therefore, as noted at 632, the UE may pre-set a certain number of retransmission without responding according to the HARQ ACK/NACK feedback (which the target cell cannot provide).

Once the baton handover completes at 616 (e.g. the UE losing the DL, or a timer timeout), then the UE may switch the DL to the target cell (establishing DL channels 618). As illustrated at 620, the UE may also establish HS-SICH. The UE sends the PHYSICAL CHANNEL RECONFIGURATION COMPLETE message, at 622) to the target cell as response. With PHYSICAL CHANNEL RECONFIGURATION COMPLETE message, some other channels (HS-SICH and E-HICH) resume their operations. That is, the UE can resume reporting CQI and ACK/NACK and receiving ACK/NACK, as noted at 624.

In order to switch from non-scheduled to scheduled transmission grant, the target cell may send a RADIO BEARER RECONFIGURATION message 626 to command the change. The UE may reply with a RADIO BEARER RECONFIGURATION COMPLETE message 630. Scheduled transmission grant using the E-AGCH may then resume, as noted at 628.

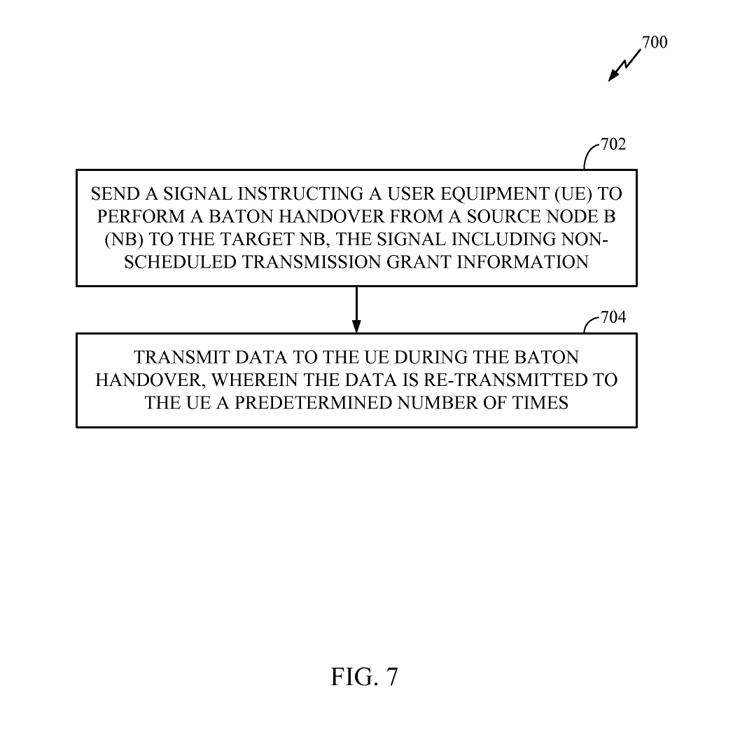

By maintaining HSPA during the baton handover, as described above, higher data throughput and a better user experience may be achieved. FIGS. 7-9 illustrate example functional blocks corresponding to operations that may be performed by the different entities shown in FIG. 6.

For example, FIG. 7 illustrates example functional blocks corresponding to operations 700 that may be performed by a source NB to implement the functional characteristics of one aspect of the present disclosure.

At 702, the source NB sends a message instructing the UE to perform a baton handover from the source NB to the target NB, the message including non-scheduled transmission grant information. As noted above, the UE may transmit to the target NB in accordance with the non-scheduled transmission grant information during the baton handover. The non-scheduled transmission grant information may indicate a predetermined number of times the UE should re-transmit data to the target NB.

At 704, the source NB continues to transmit data to the UE during the baton handover, wherein data is re-transmitted to the UE for a predetermined number of re-transmissions. Thus, while the data may be transmitted without receiving feedback from the UE indicating whether the transmissions were successfully received, the multiple transmissions may increase the likelihood of successful transmissions. Further, according to certain aspects, the UE may perform combining of the re-transmitted data to assist in successful decoding of the downlink transmissions.

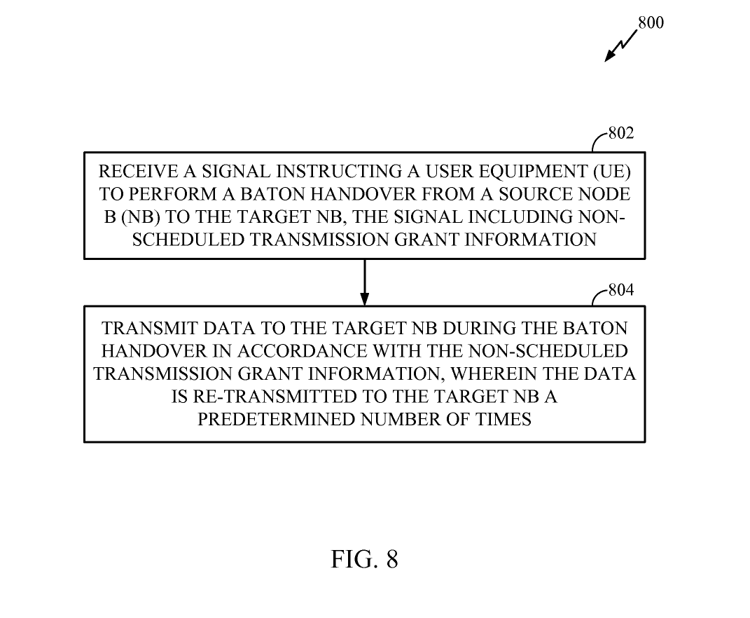

FIG. 8 illustrates example functional blocks corresponding to operations 800 that may be performed by a UE to implement the functional characteristics of one aspect of the present disclosure.

At 802, the UE receives a message instructing the UE to perform a baton handover from a source NB to a target NB, the message including non-scheduled transmission grant information.

At 804, the UE transmits data to the target NB during the handover transition period in accordance with the non-scheduled transmission grant information, wherein data is re-transmitted to the target NB for a predetermined number of re-transmissions. Thus, while the data may be transmitted without receiving feedback from the target NB indicating whether the transmissions were successfully received, the multiple transmissions may increase the likelihood of successful transmissions. Further, according to certain aspects, the target NB may perform combining of the re-transmitted data to assist in successful decoding of the uplink transmissions.

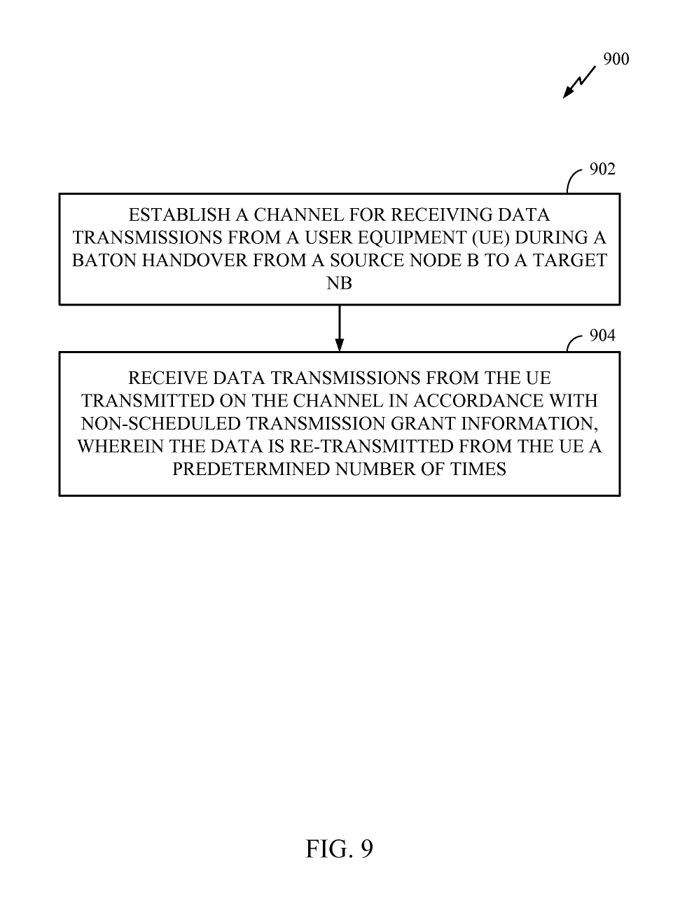

FIG. 9 illustrates example functional blocks corresponding to operations 900 that may be performed by a target NB to implement the functional characteristics of one aspect of the present disclosure.

At 902, the target NB establishes a channel for receiving data transmissions from a UE during a baton handover. At 904, the target NB receives data transmissions from the UE transmitted on the channel in accordance with non-scheduled transmission grant information, wherein the data is re-transmitted from the UE a predetermined number of times.

As described above, the predetermined number of re-transmissions may be indicated in the Non-scheduled transmission grant IE. As noted above, according to certain aspects, the target NB may perform combining of the re-transmitted data to assist in successful decoding of the uplink transmissions

In one configuration, an apparatus for wireless communication (e.g., the Node B 310 acting as a Source NB) includes means for sending a signal instructing a user equipment (UE) to perform a baton handover from a source Node B (NB) to the target NB, the signal including non-scheduled transmission grant information and transmitting data to the UE during the baton handover, wherein the data is re-transmitted to the UE a predetermined number of times. In one aspect, the aforementioned means may be the transmit processor 320 or the controller/processor 340 configured to perform the functions recited by the aforementioned means. In another aspect, the aforementioned means may be a module or any apparatus configured to perform the functions recited by the aforementioned means.

In one configuration, the apparatus for wireless communication (e.g., the UE 350) includes means for receiving a signal instructing a user equipment (UE) to perform a baton handover from a source Node B (NB) to the target NB, the signal including non-scheduled transmission grant information and means for transmitting data to the target NB during the baton handover in accordance with the non-scheduled transmission grant information, wherein the data is re-transmitted to the target NB a predetermined number of times. In one aspect, the aforementioned means may be the receive processor 370 or the controller/processor 390 configured to perform the functions recited by the aforementioned means. In another aspect, the aforementioned means may be a module or any apparatus configured to perform the functions recited by the aforementioned means.

In one configuration, an apparatus for wireless communication (e.g., the Node B 310 acting as a Target NB) includes means for establishing a channel for receiving data transmissions from a user equipment (UE) during a baton handover from a source Node B (NB) to a target NB and means for receive data transmissions from the UE transmitted on the channel in accordance with non-scheduled transmission grant information, wherein the data is re-transmitted from the UE a predetermined number of times. In one aspect, the aforementioned means may be the transmit processor 320 or the controller/processor 340 configured to perform the functions recited by the aforementioned means. In another aspect, the aforementioned means may be a module or any apparatus configured to perform the functions recited by the aforementioned means.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for performing a baton handover from a source node B (NB) to a target NB by a user equipment (UE), comprising:
receiving a first signal instructing the UE to perform the baton handover from the source NB to the target NB, the first signal including non-scheduled transmission grant information; and
transmitting data to the target NB during the baton handover in accordance with the non-scheduled transmission grant information, wherein the data is re-transmitted to the target NB a predetermined number of times.

2. The method of claim 1, wherein the predetermined number is dependent based, at least in part, on a channel quality indication (CQI).

3. The method of claim 1, wherein the signal instructing the UE to perform the baton handover indicates the predetermined number.

4. The method of claim 1, wherein the data is re-transmitted without receiving feedback from the target NB indicating whether the transmissions were successfully received.

5. The method of claim 1, further comprising receiving data re-transmitted from the source NB a predetermined number times.

6. The method of claim 5, further comprising performing combining operations for data re-transmitted from the source NB.

7. The method of claim 1, wherein the non-scheduled transmission grant information comprises a repetition period field indicating sub-frames in which the UE is to transmit data to the target NB.

8. An apparatus for performing a baton handover from a source node B (NB) to a target NB by a user equipment (UE), comprising:
means for receiving a first signal instructing the UE to perform the baton handover from the source NB to the target NB, the first signal including non-scheduled transmission grant information; and
means for transmitting data to the target NB during the baton handover in accordance with the non-scheduled transmission grant information, wherein the data is re-transmitted to the target NB a predetermined number of times.

9. The apparatus of claim 8, wherein the predetermined number is dependent based, at least in part, on a channel quality indication (CQI).

10. The apparatus of claim 8, wherein the signal instructing the UE to perform the baton handover indicates the predetermined number.

11. The apparatus of claim 8, wherein the data is re-transmitted without receiving feedback from the target NB indicating whether the transmissions were successfully received.

12. The apparatus of claim 8, further comprising means for receiving data re-transmitted from the source NB a predetermined number times.

13. The apparatus of claim 12, further comprising means for performing combining operations for data re-transmitted from the source NB.

14. The apparatus of claim 8, wherein the non-scheduled transmission grant information comprises a repetition period field indicating sub-frames in which the UE is to transmit data to the target NB.

15. An apparatus for performing a baton handover from a source node B (NB) to a target NB by a user equipment (UE), comprising:
at least one processor configured to:
receive a first signal instructing the UE to perform the baton handover from the source NB to the target NB, the first signal including non-scheduled transmission grant information; and
transmit data to the target NB during the baton handover in accordance with the non-scheduled transmission grant information, wherein the data is re-transmitted to the target NB a predetermined number of times; and
a memory coupled to the at least one processor.

16. The apparatus of claim 15, wherein the predetermined number is dependent based, at least in part, on a channel quality indication (CQI).

17. The apparatus of claim 15, wherein the signal instructing the UE to perform the baton handover indicates the predetermined number.

18. The apparatus of claim 15, wherein the data is re-transmitted without receiving feedback from the target NB indicating whether the transmissions were successfully received.

19. The apparatus of claim 15, wherein the at least one processor is further configured to receive data re-transmitted from the source NB a predetermined number times.

20. The apparatus of claim 19, wherein the at least one processor is further configured to perform combining operations for data re-transmitted from the source NB.

21. The apparatus of claim 15, wherein the non-scheduled transmission grant information comprises a repetition period field indicating sub-frames in which the UE is to transmit data to the target NB.

22. A computer-program product for performing a baton handover from a source node B (NB) to a target NB by a user equipment (UE), the computer-program product comprising:
a computer-readable medium comprising code for:
receiving a first signal instructing the UE to perform the baton handover from the source NB to the target NB, the first signal including non-scheduled transmission grant information; and
transmitting data to the target NB during the baton handover in accordance with the non-scheduled transmission grant information, wherein the data is re-transmitted to the target NB a predetermined number of times.

23. A method for instructing a user terminal (UE) to perform a baton handover from a source NB to a target NB, comprising:
sending a signal instructing the UE to perform the baton handover from the source NB to the target NB, the signal including non-scheduled transmission grant information for the UE to transmit data to the target NB during the baton handover; and
continuing to transmit data to the UE during the handover transition period, wherein the data is re-transmitted to the UE for a predetermined number of times.

24. The method of claim 23, wherein the predetermined number is determined, at least in part, based on a channel quality indication (CQI).

25. The method of claim 23, wherein the predetermined number is determined, at least in part, based on a radio bearer service type.

26. The method of claim 23, wherein the data is re-transmitted without receiving feedback from the UE indicating whether the transmissions were successfully received.

27. The method of claim 23, wherein the non-scheduled transmission grant information comprises a repetition period field indicating sub-frames in which the UE is to transmit data to the target NB.

28. An apparatus for instructing a user terminal (UE) to perform a baton handover from a source NB to a target NB, comprising:
means for sending a signal instructing the UE to perform the baton handover from the source NB to the target NB, the signal including non-scheduled transmission grant information for the UE to transmit data to the target NB during the baton handover; and
means for continuing to transmit data to the UE during the handover transition period, wherein the data is re-transmitted to the UE for a predetermined number of times.

29. The apparatus of claim 28, wherein the predetermined number is determined, at least in part, based on a channel quality indication (CQI).

30. The apparatus of claim 28, wherein the predetermined number is determined, at least in part, based on a radio bearer service type.

31. The apparatus of claim 28, wherein the data is re-transmitted without receiving feedback from the UE indicating whether the transmissions were successfully received.

32. The apparatus of claim 28, wherein the non-scheduled transmission grant information comprises a repetition period field indicating sub-frames in which the UE is to transmit data to the target NB.

33. An apparatus for instructing a user terminal (UE) to perform a baton handover from a source NB to a target NB, comprising:
at least one processor configured to:
send a signal instructing the UE to perform the baton handover from the source NB to the target NB, the signal including non-scheduled transmission grant information for the UE to transmit data to the target NB during the baton handover; and
continue to transmit data to the UE during the handover transition period, wherein the data is re-transmitted to the UE for a predetermined number of times; and
a memory coupled to the at least one processor.

34. The apparatus of claim 33, wherein the predetermined number is determined, at least in part, based on a channel quality indication (CQI).

35. The apparatus of claim 33, wherein the predetermined number is determined, at least in part, based on a radio bearer service type.

36. The apparatus of claim 33, wherein the data is re-transmitted without receiving feedback from the UE indicating whether the transmissions were successfully received.

37. The apparatus of claim 33, wherein the non-scheduled transmission grant information comprises a repetition period field indicating sub-frames in which the UE is to transmit data to the target NB.

38. A computer-program product for instructing a user terminal (UE) to perform a baton handover from a source NB to a target NB, the computer-program product comprising:
a computer-readable medium comprising code for:
sending a signal instructing the UE to perform the baton handover from the source NB to the target NB, the signal including non-scheduled transmission grant information for the UE to transmit data to the target NB during the baton handover; and
continuing to transmit data to the UE during the handover transition period, wherein the data is re-transmitted to the UE for a predetermined number of times.

39. A method for communicating with a user terminal (UE) during a baton handover from a source base station (NB) to a target NB, comprising:
establishing a channel for receiving data transmissions from the UE during the baton handover during which the target NB does not transmit to the UE; and
receiving data transmissions from the UE transmitted on the channel in accordance with non-scheduled transmission grant information, wherein the data is re-transmitted to the UE for a predetermined number of times.

40. The method of claim 39, wherein the data is re-transmitted without the UE feedback from the target NB indicating whether the transmissions were successfully received.

41. The method of claim 39, further comprising performing combining operations for data re-transmitted from the UE.

42. An apparatus for communicating with a user terminal (UE) during a baton handover from a source base station (NB) to a target NB, comprising:
means for establishing a channel for receiving data transmissions from the UE during the baton handover during which the target NB does not transmit to the UE; and
means for receiving data transmissions from the UE transmitted on the channel in accordance with non-scheduled transmission grant information, wherein the data is re-transmitted to the UE for a predetermined number of times.

43. The apparatus of claim 42, wherein the data is re-transmitted without the UE feedback from the target NB indicating whether the transmissions were successfully received.

44. The apparatus of claim 42, further comprising means for performing combining operations for data re-transmitted from the UE.

45. An apparatus for communicating with a user terminal (UE) during a baton handover from a source base station (NB) to a target NB, comprising:
at least one processor configured to:
establish a channel for receiving data transmissions from the UE during the baton handover during which the target NB does not transmit to the UE; and
receive data transmissions from the UE transmitted on the channel in accordance with non-scheduled transmission grant information, wherein the data is re-transmitted to the UE for a predetermined number of times; and
a memory coupled to the at least one processor.

46. The apparatus of claim 45, wherein the data is re-transmitted without the UE feedback from the target NB indicating whether the transmissions were successfully received.

47. The apparatus of claim 45, wherein the at least one processor is further configured to perform combining operations for data re-transmitted from the UE.

48. A computer-program product for communicating with a user terminal (UE) during a baton handover from a source base station (NB) to a target NB, the computer-program product comprising:
a computer-readable medium comprising code for:
establishing a channel for receiving data transmissions from the UE during the baton handover during which the target NB does not transmit to the UE; and
receiving data transmissions from the UE transmitted on the channel in accordance with non-scheduled transmission grant information, wherein the data is re-transmitted to the UE for a predetermined number of times.
